(19) United States
(12) Patent Application Publication
(10) Pub. No.: US 2023/0310979 A1
(43) Pub. Date: Oct. 5, 2023

(54) Stackable Block Game

(71) Applicant: Adrian Daniel Cipri, South Salem, NY (US)

(72) Inventor: Adrian Daniel Cipri, South Salem, NY (US)

(21) Appl. No.: 18/206,208

(22) Filed: Jun. 6, 2023

Related U.S. Application Data
(60) Provisional application No. 63/154,783, filed on Feb. 28, 2021.

(51) Int. Cl. A63F 9/04; A63F 9/00; A63F 9/26; A63F 13/80

(52) U.S. Cl. CPC A63F 9/0413; A63F 9/0073; A63F 9/26; A63F 13/80

(57) ABSTRACT

A method for a stackable block game, where first a version of the game to play is decided. Then, one or more than one player rolls a pair of dice. Next, determining if the roll is over six, a player stacks one big game piece. If the roll is equal to or under six, wherein the player stacks one medium game piece. If the roll is double sixes, the player stacks one log. If the roll is double fours, the player places one small game piece and either one big game piece or one medium game piece. If the roll is double ones, the player places one snake game piece, or two small game pieces for any other set of doubles. Next, determining if any game pieces are all used, the player must skip a turn. Finally, when all game piece are played, and completing the game.

### CROSS-REFERENCE TO RELATED APPLICATIONS

This Application claims the benefit under 35 U.S.C. § 119(e) of U.S. Provisional Pat. Application Ser. No. 61/796, 505, filed on 2021-02-28, and is a continuation of U.S. Pat. Application Ser. No. 17/681,837 the contents of which are incorporated herein by reference in their entirety.

### FIELD OF THE INVENTION

The present invention is in the technical field of stackable block game and more particularly to a game which employs a set of game blocks which are manipulated in accordance with a set of rules.

### BACKGROUND

Games with pieces or blocks are well known to the people of various geographies for a long time. While there are different games involving game pieces and blocks and there are multiple ways in which such games are played, the most popular types of games that employ game pieces or blocks are puzzle games and tower building games. For example, some puzzle games involve assembling some pieces or blocks in such an order that once the pieces are assembled, a picture or a word is formed. Likewise, most tower building games are designed to stack the pieces or blocks one on top of another in order to build a tower.

Games that employ stacking blocks to build a tower are considered entertaining among children as well as adults. One of the most popular games involving stackable blocks and tower building is Jenga®. Jenga® starts with building a tower to set up the game. The initial tower has eighteen levels of three blocks placed adjacent to one another at right angles to the previous level. Once the tower is built, blocks (one at a time) are removed from any level, except the one below the incomplete top level, of the tower, and the removed blocks are placed on the topmost level to complete it. Only one hand should be used at a time when removing pieces from the tower. The game continues until the tower falls due to removal of a key block or poor placement of some block.

Attempts have been made, although unsuccessfully, increase the level of difficulty and the entertainment of the game. Some of the variants of Jenga® include Jenga Xtreme, which uses parallelogram-shaped blocks that can create some interesting leaning towers, Jenga XXL and Jenga Giant, which can reach 5 feet (150 cm) or higher in play and allows players to use two hands to move the blocks, Jenga Truth or Dare, which has three colors of blocks instead of just the natural color of Jenga®.

Another similar game and a variant of Jenga® is Jenga ultimate, which employs of set of colored game blocks and a rolling dice. A player rolls the dice having colored faces matching the colors on the game pieces, with the color of the uppermost die face determining the color of the game piece which is to be removed from the tower. By limiting the number of blocks which can be removed, the level of difficulty of the game is increased.

As can be seen, various attempts have been made to solve the problems which may be found in the related art but have been unsuccessful. However, it is still desirable to provide a stacking game with increasing levels of entertainment and further greater levels of difficulty by engaging players in performing activities as part of the game.

Therefore, there is a need for a game which employs a set of game blocks which are manipulated in accordance with a set of rules, overcoming the limitations of the prior art.

### BRIEF DESCRIPTION OF THE DRAWINGS

The present invention overcomes the limitations of the prior art by providing a game which employs a set of game blocks which are manipulated in accordance with a set of rules.

These and other features, aspects and advantages of the present invention will become better understood with regard to the following description, appended claims, and accompanying figures where:

FIG. 1 is a flowchart of some steps of a method for playing a stackable block game, according to one embodiment;

FIG. 2 is a set of stackable blocks useful for playing the game, according to one embodiment of the present invention;

FIG. 3 is a first option for playing the game where one or more players try to create a tree like structure;

FIG. 4 is a second option for playing the game, wherein one or more players try to make the next game play knock the structure down;

FIG. 5 is a first starting point of game play;

FIG. 6 is a second starting point of game play;

FIG. 7 is a third starting point of game play;

FIG. 8 is a fourth starting point of game play;

FIG. 9 is a fifth starting point of game play; and

FIG. 10 is a sixth starting point of game play.

### SUMMARY

The present invention overcomes the limitations of the prior art by providing a method for a stackable block game, where first on a version of the game to play is determined, Where the game can be played by one or more than one person. Then, a player rolls a pair of dice. Next, determining if the roll is over six, wherein a player stacks one big blue game piece on a game base. Then, determining if the roll is equal to or under six, wherein the player stacks one medium yellow ochre game piece on the game base. Next, determining if the roll is double sixes, wherein the player stacks one big red log on the game base. Then, determining if the roll is double fours, wherein the player places one small black and yellow bumble bee and either one big blue game piece or one medium yellow ochre game piece on the game base. Next, determining if the roll is double ones, wherein the player places one green snake game piece on the game base. Then, placing two small yellow and black game pieces on the base for any other set of doubles, where the small game pieces are placed side by side touching one another or one on top of each other. Next, determining if any individual game pieces are all used, wherein the player must skip a turn until the player rolls a number on the die that has a corresponding available game piece to be played. Finally, determining when all game piece are played, and completing the game.

The game further comprising the steps of first, guessing the next dice roll if the player that rolls snake eyes. Then, determining if the player guessed the next roll correctly, where if the guess is correct, the player can choose any other game piece to play; or if incorrect, the player must use the snake game piece.

The game is played in one of two ways: a tree or a stack. In the tree version the game pieces can be placed anywhere space is available on a provided game base. If a player knocks down a section of the tree build the player can roll back into the game by guessing the next roll of the dice, and if correct, the player must play game piece rolled. If a section of the build falls, the player that knocked it down is out, and the remaining players can continue to build on existing and still standing sections of structure. When all the game pieces have been placed on the tree like structure, the game is over.

In the stack version, one or more players create a tall tree like stack structure, where each player places game pieces to strategically make a following players move to topple the stack. Game pieces must be played in a single stack and set one on top of another starting from a first player’s roll. When playing with multiple players, a player that knocks down a stack is out, the remaining players can continue building until there is only one player remaining. The remaining player is the winner. Otherwise, the game is over when the stack falls, or the last piece is played. During team play, each team is allowed one pass to a team member after rolling the dice.

There is also provided a stackable block game comprising one or more than one blue game piece; one or more than one yellow ochre game piece; one or more than one multi colored yellow and black game piece; one or more than one red game piece; one or more than one green snake game piece; a pair of dice; and a base. Each game piece and the base are hand cut and painted from hardwoods, making each game set is unique and one of a kind due to the material used.

The one or more than one big blue game piece is over two inches in diameter and approximately one inch in height. The one or more than one yellow/ochre game piece is between 1.1 and 1.5 inches in diameter and approximately one inch in height. The one or more than one multi-colored, black and yellow game piece is one inch or smaller in diameter and approximately one inch in height. The one or more than one big red log game piece is one and one half to three inches in diameter and between two and three inches in height. The one or more than one green snake game piece is one to two inches in diameter and over three inches in height. The base for playing the game is five inches in diameter and one inch in height. The dice are preferably made of wood to compliment the game.

There is also provided a computer-implemented method for a stackable block game. The method comprises the steps of : a) executing instructions to play the game, locally, virtually, or across the Internet with other players; b) executing instructions operable on the one or more than one processor to randomly create graphic images of the game piece for playing the game; c) selecting a version of game to play, wherein there are two versions, stacks or tree, to select from; d) executing instructions to create and randomly roll a pair of dice for game play in accordance with the following game rules: 1) determining if the roll is over six, wherein a player stacks one big blue game piece on a game base; 2) determining if the roll is equal to or under six, wherein the player stacks one medium yellow ochre game piece on the game base; 3) determining if the roll is double sixes, wherein the player stacks one big red log on the game base; 4) determining if the roll is double fours, wherein the player places one small black and yellow bumble bee and either one big blue game piece or one medium yellow ochre game piece on the game base; 5) determining if the roll is double ones, wherein, the player places one green snake game piece on the game base; 6) placing two small yellow and black game pieces on the base for any other set of doubles; 7) determining if any individual game pieces are all used, wherein the player must skip a turn until the player rolls a number on the die that has a corresponding available game piece to be played; and 8) determining when all game piece are played, and completing the game.

### DETAILED DESCRIPTION OF THE INVENTION

he present invention overcomes the limitations of the prior art by providing a game which employs a set of game blocks which are manipulated in accordance with a set of rules.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. The flowcharts and block diagrams in the figures can illustrate the architecture, functionality, and operation of possible implementations of systems, methods and computer programs according to various embodiments disclosed. In this regard, each block in the flowchart or block diagrams can represent a module, segment, or portion of code, that can comprise one or more executable instructions for implementing the specified logical function(s). It should also be noted that, in some alternative implementations, the functions noted in the blocks may occur out of the order noted in the figures. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function. Additionally, each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Moreover, a storage may represent one or more devices for storing data, including read-only memory (ROM), random access memory (RAM), magnetic disk storage mediums, optical storage mediums, flash memory devices and/or other non-transitory machine readable mediums for storing information. The term “machine readable medium” includes, but is not limited to portable or fixed storage devices, optical storage devices, wireless channels and various other non-transitory mediums capable of storing, comprising, containing, executing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc. and are also referred to as an interface, where the interface is the point of interaction with software, or computer hardware, or with peripheral devices.

In the following description, certain terminology is used to describe certain features of one or more embodiments of the invention.

The term “tirckory tree” refers to a stacking game, wherein the game pieces are created from tree sections making each game piece unique.

Various embodiments provide a stackable block game. One embodiment of the present invention provides a stackable block game. In another embodiment, there is provided a method for using the system. The system and method will now be disclosed in detail.

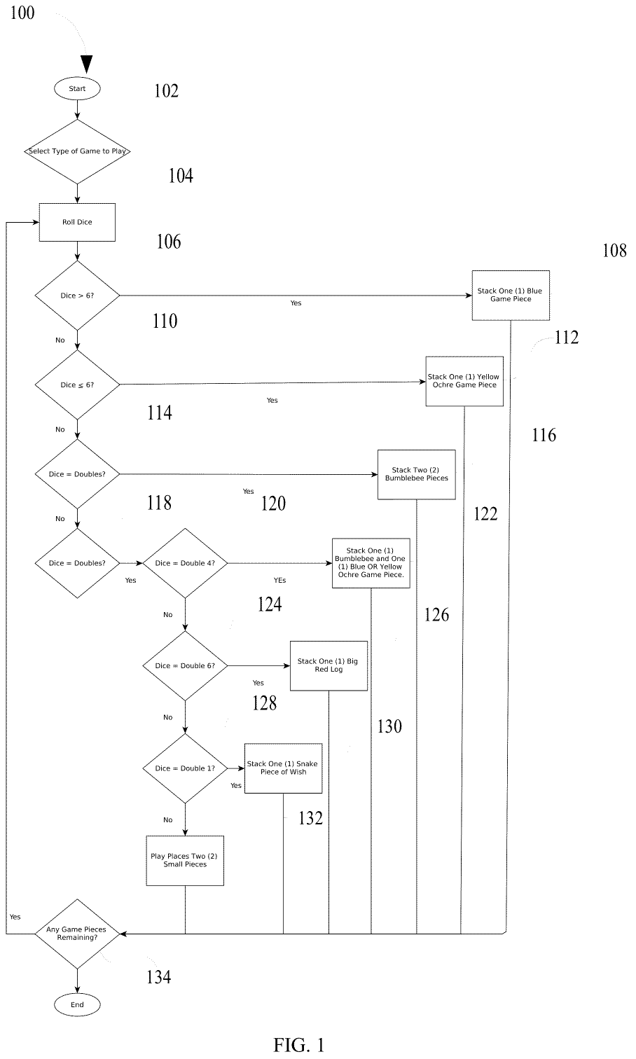

Referring now to FIG. 1, there is shown a flowchart 100 of some steps of a method for playing a stackable block game, according to one embodiment, the steps comprising, first deciding on a version to play 102. Then, rolling a pair of dice 104. Next, if the roll is over six (6) 106, a player stacks one big blue game piece 108 on a game base 214. Then, if the roll is equal to or under six (6) 110, the player stacks one medium yellow ochre game piece 112. Next, if the roll is doubles 114, except for double sixes (6), double fours (4) or double ones (1), the player places two (2) small bumble bees (yellow and black) game pieces 116 on the base 214. The game pieces in this step can be placed side by side touching or on top of one another. Then, if the roll is double fours (4) 120, the player uses one small black and yellow bumble bee and choice of one either big blue or medium yellow ochre 122. Next, if the roll is double sixes (6) 124, the player uses one big red log 126. Then, if the roll is double ones (1) or “snake eyes” 128, the player uses one green snake game piece 130. Optionally, the player that rolls snake eyes can make a wish and try to guess there number of their next roll. If the player guesses correctly, ie, the player’s wish came true, then the player can choose any other game piece to play. If the player’s wish doesn’t come true they must use the snake game piece. Next, if a certain game piece runs out 134, then the player has to skip a turn until the player rolls a number on the die that allows pieces left to be played. Finally, when all game piece are played, the game is over.

The game can be played with one or more than one person. There are a plurality of playing options. The game 100 can be a skills at balance game, a strategy game, a focus game, a teamwork game, a creativity game, etc. The game is designed to build confidence in young people as well as all others. You can play the game two ways as a tricky tree or stacks. The game can be played by one or more than one player. The game can be played as a multiplayer cooperative game, where every player is working together to build the best Tricky tree or stack. Alternatively, the game can be played as a multiplayer competitive. As can be appreciated, the game can also be play by an individual player. Also, the game can be played on a computer, virtually, or across the Internet with other players.

Additionally, as will be understood by those with skill in the art with reference to this disclosure, the game can also be computerized. For an computer implemented version of the game, random sized piece of each type can be generated by instructions operable on one or more than one processor. A storage comprises instructions operable on the one or more than one processor to randomly create graphic images of the game piece. Then, one or more than one user selects the type of game to play (stacks or trickory tree). Next, instructions create and randomly roll a pair of dice for game play in accordance with the instructions shown in the flowchart 100.

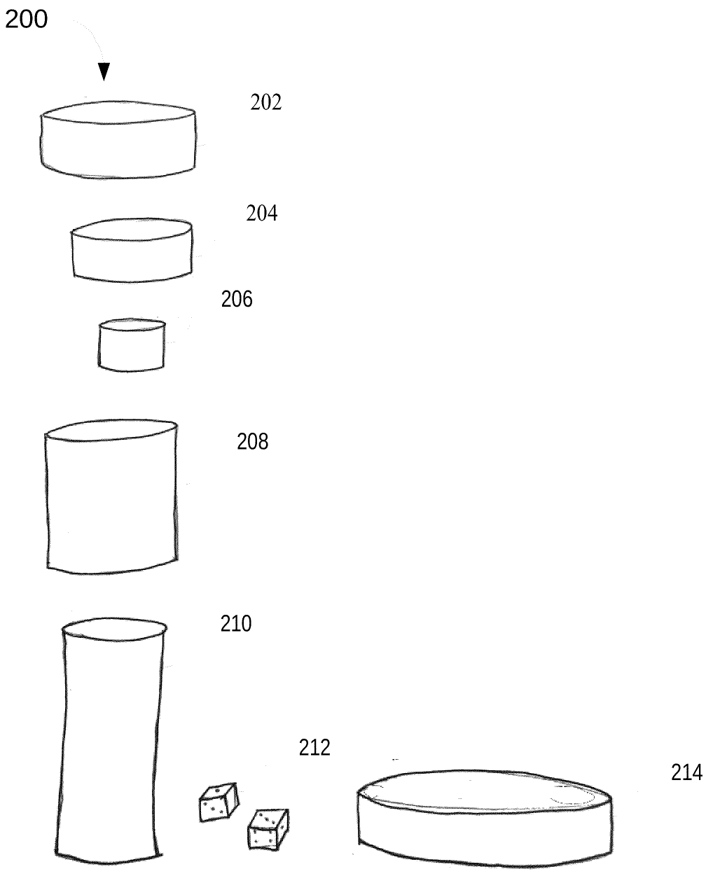

Referring now to FIG. 2, there is shown a set of stackable blocks 200 useful for playing the game, according to one embodiment of the present invention. The set of stackable blocks 200 comprises:
20 big blue game pieces 202;
20 medium yellow ochre game pieces 204;
20 small multi colored yellow and black, or bumble bees game pieces 206;
3 big red game pieces 208;
3 green snake game pieces 210;
2 dice 212; and
1 a base 214.

Each game piece 202-210 and the base 214 are hand cut and painted. The material used is a mix of hardwoods. But other materials can be used. Each game set is unique and one of a kind due to the material used. This is unlike currently available games that all consist of uniform pieces. This makes the present invention more challenging than the current art.

Each big blue game piece 202 is over two (2) inches in diameter and approximately one (1) inch in height. Each Yellow/Ochre game piece 204 is between 1.1 inches in diameter and approximately one (1) inch in height. Each multi-colored, black and yellow (or Bumble Bee) game piece 206 is one (1) inch or smaller in diameter and approximately one (1) inch in height. Each big red log game piece 208 is one and one half (1.5) to three (3) inches in diameter and two (2) to three (3) inches in height. Each green snake game piece 210 is one (1) to two (2) inches in diameter and over three (3) inches in height. The dice 212 as standard dice, but preferably are made of wood to compliment the game. Finally the base 214 for playing the game is five (5) inches in diameter and one (1) inch in height.

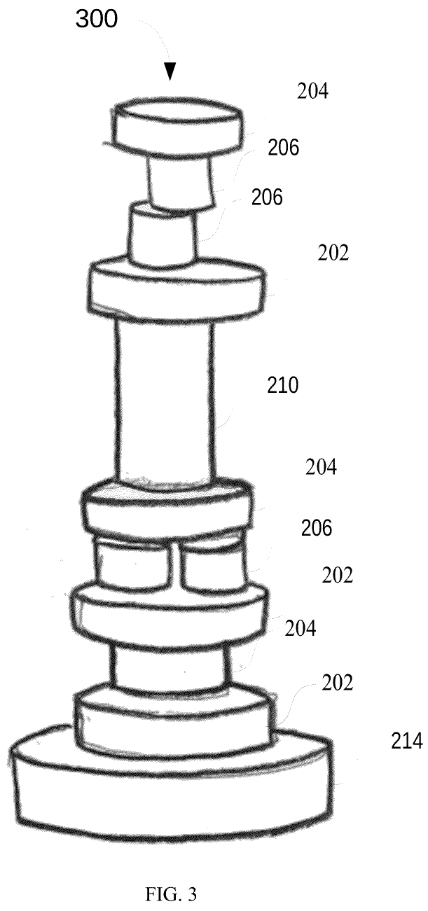

Referring now to FIG. 3, there is shown a first option 300 for playing the game 100 where one or more players try to create a tall tree like stack structure. In this option, known as stacks, the one or more than one player places game pieces 202-210 to strategically make the following players move (or just a move is there is only one player) to potentially topple the stack. As can be seen, after each dice roll, the players place game pieces 202-210 on the base 214 to strategically make the following players place a game piece 202-210 to potentially topple the stack. The game 100 is over when the stack falls or the last person places a last game piece 202-210 and is declared the winner. Optionally, during team play, each team is allowed one pass to a team member after rolling the dice.

Game pieces 202-210 must be played in a single stack starting from first player’s roll and build up one on top of another. The use of the base 214 is optional for this game.

Stacks can also be played cooperative or competitive. Single player or multiplayer Teams as well. When playing with multiple players, a player that knocks down a stack is out and the remaining players can start another new round of building. When there is only one player remaining, the remaining player is the winner.

More Game Play.

Optionally, if a player knocks down a section of a Tricky Tree build they can roll back into the game. To do this, the player previously knocked out of the game 100 can guess their next roll then they can be back in and must play game piece 202-210 rolled.

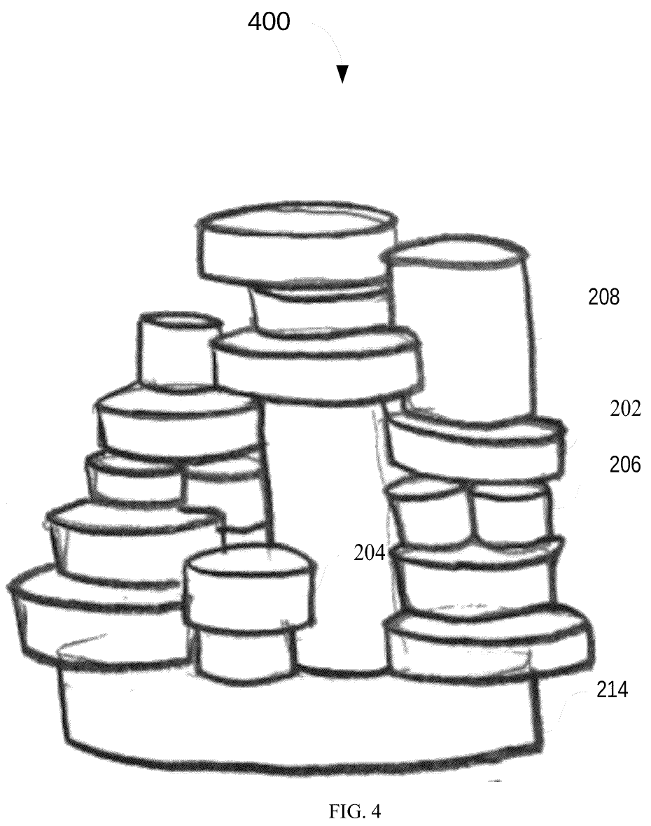

Referring now to FIG. 4, there is shown a second option 400 for playing the game 100, wherein one or more players try to make the next game play knock the structure down. Game pieces 202-210 can be placed anywhere space is available on the base 214 provided with the game set and continue to build anywhere space provides. Small game pieces 206 can be played separate from one another.

If a section of the build 400 falls, the player that knocked it down is out. Other players can continue to build on existing and still standing sections of structure known as a tricky tree 400. Optionally, a player previously out can roll back into the game 100. If they guess there roll on next turn they can be back in the game and must play that roll.

When all the game pieces 202-210 have been used, the game is over and player or players have made a Trickory Tree.

Optionally, as described above, a player previously out can roll back into the game. To do this the player, must guess the next roll on the next turn. If the guess is correct, the player can rejoin the game 100 but must play the correctly guessed dice 212 roll.

When all the game pieces 202-210 have been used the game is over and the player or players have successfully made a Trickory Tree.

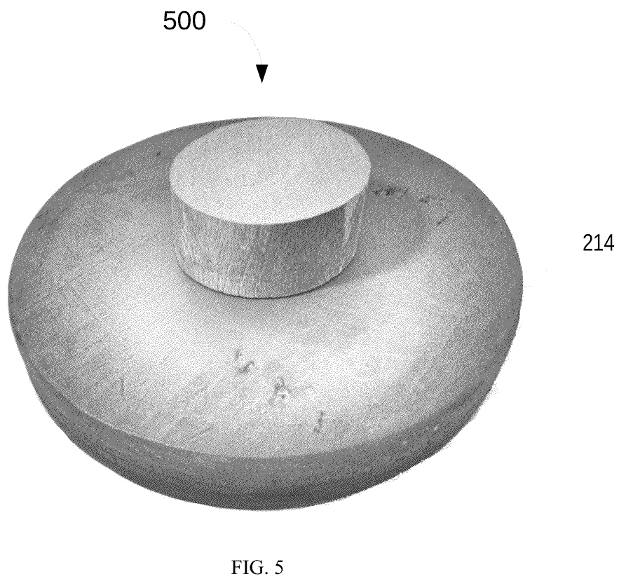

Referring now to FIGS. 5, 6, 7, 8, 9 and 10 there is shown a various starting points of game play. As shown in FIG. 5, game play starts with a medium yellow ochre game piece 204 placed in the center of the base 214.

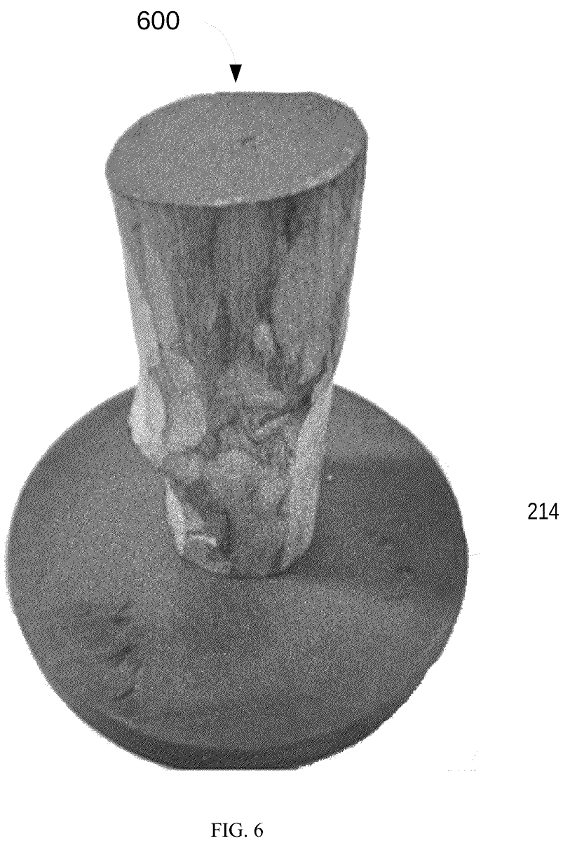

As shown in FIG. 6, game play starts with a green snake game piece 210 placed in the center of the base 214.

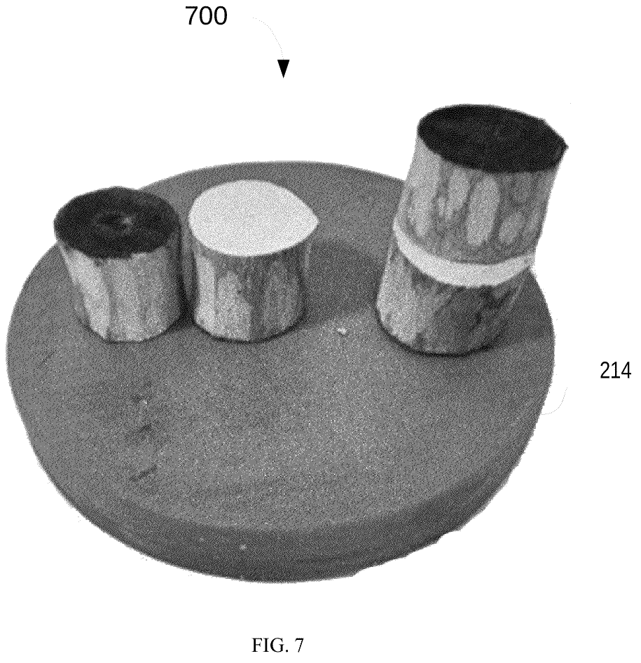

As shown in FIG. 7, game play starts with a player choosing two small yellow and black game pieces 206 and places the two game pieces 206 side by side touching one another or one on top of another, placed in the center of the base 214.

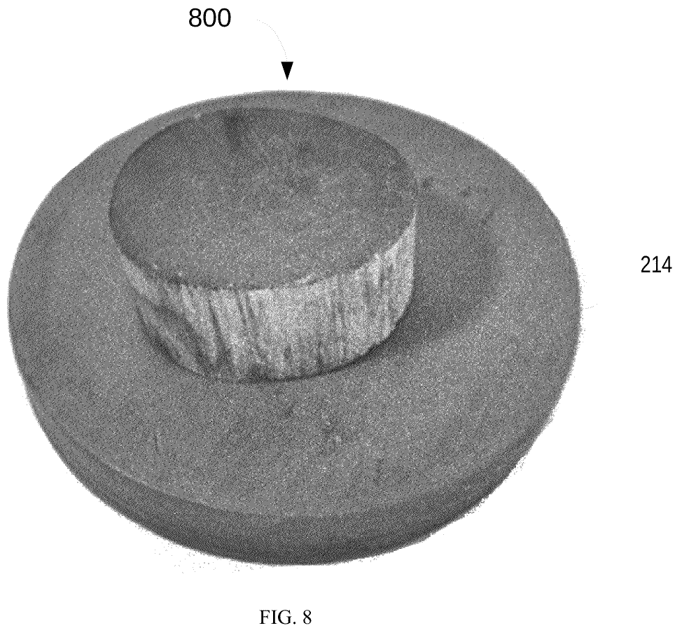

As shown in FIG. 8, game play starts with a big blue game piece 202 placed in the center of the base 214.

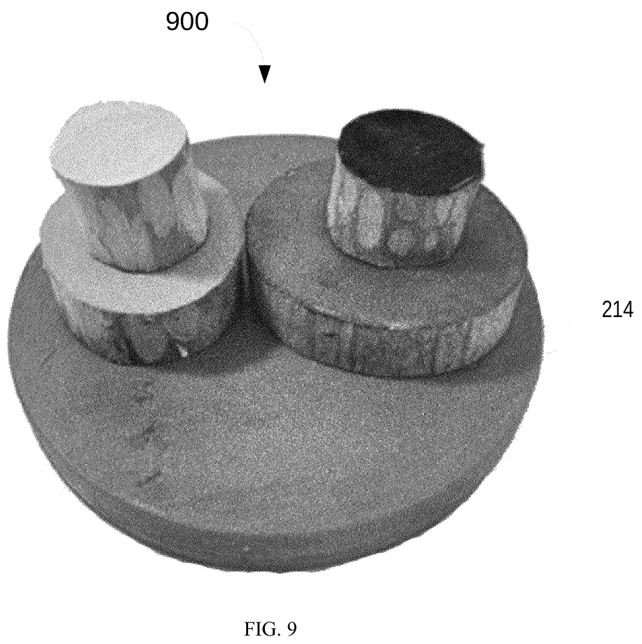

As shown in FIG. 9, game play starts with a big blue game piece 202, a medium yellow ochre game piece 204 and two small yellow and black game pieces 206 placed in the center of the base 214. Wherein, the two small yellow and black game pieces 206 are stacked on top of each of the big blue game piece 202 and the medium yellow ochre game piece 204.

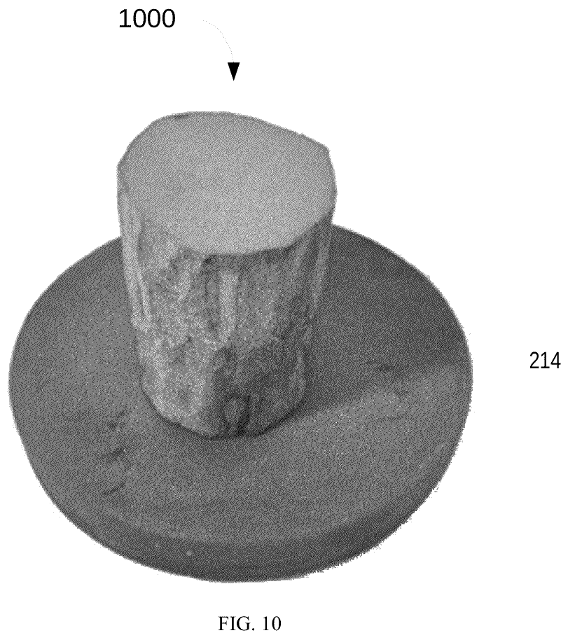

As shown in FIG. 10, game play starts with a big red game piece 208 placed in the center of the base 214.

Optionally, a player can roll the dice 212 to select the first player from the highest number rolled, or the lowest number rolled, and the corresponding game piece is placed on the base 214 and used to start the game.

What has been described is a new and improved system for a game which employs a set of game blocks which are manipulated in accordance with a set of rules, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

What is claimed is:

1. A method for a stackable block game, the steps of the method comprise:
a) deciding on a version of the game to play;
b) rolling a pair of dice.
c) determining if the roll is over six, wherein a player stacks one big blue game piece on a game base;
d) determining if the roll is equal to or under six, wherein the player stacks one medium yellow ochre game piece on the game base;
e) determining if the roll is double sixes, wherein the player stacks one big red log on the game base;
f) determining if the roll is double fours, wherein the player places one small black and yellow bumble bee and either one big blue game piece or one medium yellow ochre game piece on the game base;
g) determining if the roll is double ones, wherein the player places one green snake game piece on the game base;
h) placing two small yellow and black game pieces on the base for any other set of doubles;
i) determining if any individual game pieces are all used, wherein the player must skip a turn until the player rolls a number on the die that has a corresponding available game piece to be played; and
j) determining when all game piece are played, and completing the game.

2. The method of claim 1, wherein the game can be played by one or more than one person.

3. The method of claim 1, wherein in step g of the method, the game pieces are placed side by side touching one another or one on top of each other.

4. The method of claim 1, further comprising the steps of:
a) guessing the next dice roll if the player that rolls snake eyes; and
b) determining if the player guessed the next roll correctly, wherein:
1) if correct the player can choose any other game piece to play; and
2) if incorrect, the player must use the snake game piece.

5. The method of claim 1, wherein the game is played in one of two ways:
a) a tree, wherein:
1) the game pieces can be placed anywhere space is available on a provided game base;
2) if a player knocks down a section of the tree build the player can roll back into the game by guessing the next roll of the dice, and if correct, the player must play game piece rolled;
3) if a section of the build falls, the player that knocked it down is out, and the remaining players can continue to build on existing and still standing sections of structure; and
4) when all the game pieces have been placed on the tree like structure, the game is over; and
b) a stack, wherein:
1) one or more players create a tall tree like stack structure, wherein the one or more than one player places game pieces to strategically make a following players move to topple the stack;
2) game pieces must be played in a single stack and set one on top of another starting from a first player’s roll;
3) when playing with multiple players, a player that knocks down a stack is out, the remaining players can continue building until there is only one player remaining; and the remaining player is the winner;
4) the game is over when the stack falls, or the last piece is played; and
5) during team play, each team is allowed one pass to a team member after rolling the dice.

6. A stackable block game, the game comprising:
a) one or more than one blue game piece;
b) one or more than one yellow ochre game piece;
c) one or more than one multi colored yellow and black game piece;
d) one or more than one red game piece;
e) one or more than one green snake game piece;
f) a pair of dice; and
g) a base.

7. The stackable block game of claim 6, wherein each game piece and the base are hand cut and painted from hardwoods, wherein each game set is unique and one of a kind due to the material used.

8. The stackable block game of claim 6, wherein:
a) the one or more than one big blue game piece is over two inches in diameter and approximately one inch in height;
b) the one or more than one yellow/ochre game piece is between 1.1 and 1.5 inches in diameter and approximately one inch in height;
c) the one or more than one multi-colored, black and yellow game piece is one inch or smaller in diameter and approximately one inch in height;
d) the one or more than one big red log game piece is one and one half to three inches in diameter and between two and three inches in height;
e) the one or more than one green snake game piece is one to two inches in diameter and over three inches in height; and
f) the base for playing the game is five inches in diameter and one inch in height.

10. The stackable block game of claim 6, wherein the dice are preferably made of wood to compliment the game.

11. A computer-implemented method for a stackable block game, the method comprising the steps of:
a) executing instructions to play the game, locally, virtually, or across the Internet with other players;
b) executing instructions operable on the one or more than one processor to randomly create graphic images of the game piece for playing the game;
c) selecting a version of game to play, wherein there are two versions, stacks or tree, to select from;
d) executing instructions to create and randomly roll a pair of dice for game play in accordance with the following game rules:
1) determining if the roll is over six, wherein a player stacks one big blue game piece on a game base;
2) determining if the roll is equal to or under six, wherein the player stacks one medium yellow ochre game piece on the game base;
3) determining if the roll is double sixes, wherein the player stacks one big red log on the game base;
4) determining if the roll is double fours, wherein the player places one small black and yellow bumble bee and either one big blue game piece or one medium yellow ochre game piece on the game base;
5) determining if the roll is double ones, wherein, the player places one green snake game piece on the game base;
6) placing two small yellow and black game pieces on the base for any other set of doubles;
7) determining if any individual game pieces are all used, wherein the player must skip a turn until the player rolls a number on the die that has a corresponding available game piece to be played; and
8) determining when all game piece are played, and completing the game.
